(19) United States
(12) Patent Application Publication
(10) Pub. No.: US 2014/0177612 A1
(43) Pub. Date: Jun. 26, 2014

(54) SCALABLE WIRELESS COMMUNICATION SERVICE DISCOVERY

(71) Applicants: Carlos Cordeiro, Portland, OR (US); Necati Canpolat, Beaverton, OR (US); Emily H. Qi, Portland, OR (US); Bahareh Bahar Sadeghi, Portland, OR (US)

(72) Inventors: Carlos Cordeiro, Portland, OR (US); Necati Canpolat, Beaverton, OR (US); Emily H. Qi, Portland, OR (US); Bahareh Bahar Sadeghi, Portland, OR (US)

(21) Appl. No.: 13/725,053

(22) Filed: Dec. 21, 2012

(51) Int. Cl. H04W 8/00

(52) U.S. Cl. CPC H04W 8/005
USPC 370/338

(57) ABSTRACT

Some embodiments described herein include apparatuses and methods to send a first message from a first wireless communication station during service discovery to discover a service supported by a second wireless communication station. The first wireless communication may also send a second message to the second wireless communication station if the first wireless communication station receives a response message from the second wireless communication station indicating that the service included in the first message is supported by the second wireless communication station. The second message may include more information about the service than the first message. The first message may be sent before a wireless connection is established between the first and second wireless communication stations. Other embodiments including additional apparatuses and methods are described.

### TECHNICAL FIELD

Embodiments described herein pertain to wireless communication. Some embodiments relate to discovery of services among wireless communication stations.

### BACKGROUND

Service discovery is a wireless communication method that enables a wireless communication device to find a service provided by another wireless communication device. For example, a mobile device (e.g., smartphone) having no printing capability may seek a service (e.g., printing service) from a printer to print an item (e.g., a document or a picture) from the mobile device. In this example, the mobile device may use service discovery to find a service provided by the printer in order to print the item. Some conventional service discovery methods include Universal Plug and Play (UPnP), Bonjour, and others. In some cases, using conventional service discovery methods in some wireless networks may cause communication traffic congestion, increased power consumption, or both.

### BRIEF DESCRIPTION OF THE DRAWINGS

FIG. 1 shows a block diagram of stations wirelessly connected to each other in a wireless network, according to some embodiments described herein.

FIG. 2 is communication flow diagram showing an example service discovery between the stations of FIG. 1, according to some embodiments described herein.

FIG. 3 shows a block diagram of a station including an interface and a module configured to perform wireless communication, according to some embodiments described herein.

### DETAILED DESCRIPTION

FIG. 1 shows a block diagram of stations 101 and 102 that may wirelessly communicate with each other through a wireless connection 140 within a wireless network 100, according to some embodiments described herein. Stations 101 and 102 may include wireless communication stations, such as stations defined according to IEEE 802.11 standards or other communication standards. For example, station 101 or station 102 may include a computer (e.g., laptop, tablet, or desk top), a television (TV), a mobile phone (e.g., smartphone), an access point (AP), a digital camera, a monitor, a printer, a gaming station, and other electronic equipment capable of performing wireless communication according to a wireless communication standard, such as IEEE 802.11 standards or other standards. Station 101 or 102 may be a mobile station or a fixed station. Stations 101 and 102 may wirelessly communicate directly with each other in wireless network 100 without an intermediate entity (e.g., without an access point (AP)).

Stations 101 and 102 may be in proximity of each other (e.g., 100 meters or less, or another distance), such that they may communicate with each other within a range (e.g., within wireless network 100), such as a range according to IEEE 802.11 standards or other standards.

Each of stations 101 and 102 may include medium access control (MAC) and physical layer (PHY) interface according to IEEE 802.11 standards or other standards. Stations 101 and 102 may include wireless fidelity (Wi-Fi) enabled stations developed and certified by the Wi-Fi Alliance. Stations 101 and 102 may also include wireless gigabit (WiGig) enabled stations developed and certified by the WiGig Alliance.

Stations 101 and 102 may perform service discovery to enable one station (e.g., station 101) to discover a service (or services) supported (e.g., provided) by the other station (e.g., station 102).

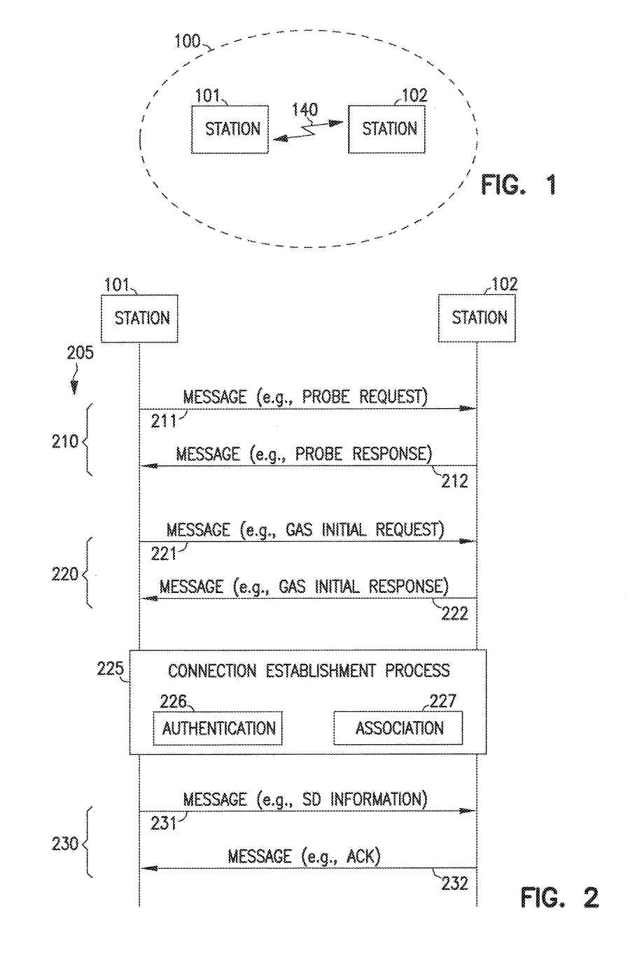

FIG. 2 is communication flow diagram showing an example service discovery 205 between the stations 101 and 102 of FIG. 1, according to some embodiments described herein. Stations 101 and 102 may perform service discovery 205, so that one station (e.g., station 101) may use a service (e.g., printing, display, or other services) offered by the other station (e.g., station 102). Service discovery 205 may be performed by stations 101 and 102 with or without user intervention.

As shown in FIG. 2, service discovery 205 may include different phases (e.g., multiple phases) 210, 220, and 230. Stations 101 and 102 may perform connection establishment process 225 between phases 220 and 230 to allow stations 101 and 102 to establish a wireless connection between them. Connection establishment process 225 may include an authentication procedure 226 and an association procedure 227. In some cases, authentication procedure 226 may be omitted.

As shown in FIG. 2, phases 210 and 220 may occur before authentication procedure 226 and association procedure 227 are performed (e.g., occur before a wireless connection is established between stations 101 and 102). Thus, phases 210 and 220 may be referred to as pre-association service discovery. Phase 230 may occur after authentication procedure 226 and association procedure 227 are performed (e.g., occur after a wireless connection is established between stations 101 and 102). Thus, phase 230 may be referred to as post-association service discovery.

In order to provide a robust user experience when operating in a wireless network, such as wireless network 100, two aspects of service discovery (e.g., service discovery 205) may be considered: pre-association and post-association. The pre-association (e.g., occurring during phase 210, 220, or both) may provide basic information that may allow a user or a station to select another station (e.g., another device) to connect to before the stations perform an association procedure (e.g., association procedure 227). The stations may perform the association procedure only after they make a decision to connect based on the type of station (e.g., a TV, computer, a phone) and specific capabilities of the station. The post-association (e.g., occurring during phase 230) may provide a complete set of information about services offered by a station. Protocols/solutions for post-association may be service-specific. For example, a Universal Serial Bus (USB) may have service discovery protocols and solutions different from those of a High-Definition Multimedia Interface (HDMI).

In service discovery 205 in FIG. 2, a succeeding phase among phases 210, 220, and 230 may provide more information (e.g., more service-specific information) about a service than the preceding phase. For example, phase 220 may provide more service-specific information than phase 210. Phase 230 may provide more service-specific information than phase 220. If information exchanged in service discovery 205 satisfies both stations 101 and 102 (e.g., in phases 210 and 220), then stations 101 and 102 may complete service discovery 205 and establish a wireless connection between them. Service discovery 205 may be terminated at anytime (e.g., during any of phases 210, 220, and 230) if information exchanged between station 101 or station 102 in any of phases 210, 220, and 230 does not satisfy station 101 or 102. Either station 101 or station 102 may terminate service discovery 205.

In the following example of service discovery 205, station 101 is assumed to be the station (e.g., a laptop computer) that requests a service (e.g., a High Definition display) from another station (e.g., a TV), such as station 102. The example also assumes that station 102 supports the service that station 101 requests.

In phase 210, station 101 may send (e.g., broadcast) a message 211. Message 211 may include one more frames. Examples of such frames may include one or more probe request frames. Message 211 may include limited (e.g., minimum) information about station 101 and limited (e.g., minimum) information about the service that station 101 requests. For example, message 211 may include the name (e.g., identification, such as service set identification (SSID)) of station 101 and a general description of a particular service that station 101 requests (and may use). The general description of the particular service in message 211 may include information about the service to be discovered, and such information includes only the type of service without additional specific information about the service. The type of service may include one or more video/audio (e.g., HDMI), display (e.g., Wi-Fi display), data transfer (e.g. USB), and printing. Specific information (e.g., detailed information) about the service may be exchanged between stations 101 and 102 in a subsequent phase (or phases) of service discovery 205. Specific information may include details such as whether a printer (e.g., type of service) is a color or black and white printer, version number (e.g., USB 1.0, 2.0, or 3.0) of a USB device (e.g., type of service), or other specific information. Specific information may be omitted from message 211 (e.g., omitted from request frames sent by station 101) during phase 210.

In phase 210 in FIG. 2, since station 102 is assumed to have a capability to support the service indicated in message 211 that station 101 requests, station 102 may send a message (e.g., response message) 212 to station 101 in response to message 211. Message 212 may include one more frames. Example of such frames may include one or more probe response frames. Message 212 may include limited information about station 102. For example, message 212 may include the name (e.g., SSID) of station 102 and a general description of the particular service that station 101 indicates in message 211. In order to reduce overhead, messages (e.g., 211 and 212) in phase 210 may not include service information such as vendor name, service capabilities, service version, service function, and user friendly text associated with the service.

Stations 101 and 102 may discover themselves based on information included in messages 211 and 212 and decide to proceed to a next phase (e.g., phase 220, 230, or both) to connect with each other.

In the above example, if station 102 does not support the service indicated in message 211 sent by station 101, then station 102 may not respond to message 211 or may respond to message 211 indicating that it does not support the requested service. In this case, service discovery 205 between stations 101 and 102 may be terminated at phase 210. Phases 220 and 230 and connection establishment process 225 may not be performed. Alternatively, if either station 101 or station 102 decides not to connect to the other, then service discovery 205 may also be terminated at phase 210 (e.g., after messages 211 and 212 are sent), regardless of whether or not station 102 supports the service requests by station 101.

Phase 220 in FIG. 2 shows an example of messages 221 and 222 exchanged between stations 101 and 102 after stations 101 and 102 decide to connect to each other. Messages 221 and 222 may include additional (e.g., more detailed) information about stations 101 and 102 and additional information about the service indicated in message 211 or message 212. For example, messages 221 and 222 may include information such as vendor name, service capabilities, service version, service function, and user friendly text associated with the service. As described above, such information may be excluded from messages 211 and 221 in phase 210 to reduce overhead.

Each of messages 221 and 222 may include one or more frames. For example, message 221 may include an IEEE 802.11 generic advertisement service (GAS) initial request frame, and message 222 may include an IEEE 802.11 GAS initial response frame. In another example, in addition to the GAS initial request and response frames, message 221 may also include an IEEE 802.11 GAS comeback request frame, and message 222 may also include an IEEE 802.11 GAS comeback response frame.

As an example, if station 101 is a USB device, message 222 may include information requesting whether the device is a USB mouse, USB keyboard, USB hard drive, or other type of USB device. Message 221 may include information requesting the device's vendor, protocol version (e.g., USB 2 or USB 3), capabilities (2-button mouse or 3-button mouse), and other detailed information about the service supported by station 102.

Service discovery 205 may skip phase 220 if information (e.g., information included in messages 211 and 212) exchanged between stations 101 and 102 is sufficient for station 101 or 102 to make a decision to continue to connect to each other. For example, if stations 101 and 102 are USB device and USB host, respective, then phase 220 may be skipped.

Stations 101 and 102 may perform authentication procedure 226 and association procedure 227 after phases 210 and 220. Alternatively, if phase 220 is skipped, as described above, stations 101 and 102 may perform authentication procedure 226 and association procedure 227 directly after phase 210. After authentication procedure 226 and association procedure 227 are successfully performed, a wireless connection between stations 101 and 102 may be established, and stations 101 and 102 may become fully operational and connected with each other.

Phase 230 in FIG. 2 may occur in post-association, which is after a wireless connection is established between stations 101 and 102. Post-association protocol may start in phase 230 and may be responsible for additional service discovery exchanges while stations 101 and 102 remain associated. Information (e.g., included in messages 231 and 232) exchanged between stations 101 and 102 in phase 230 may include service-specific information to ensure correct operation of the service (e.g., the service requested by station 101). Message 231 may include one more frames carrying additional service discovery (SD) information. Message 232 may include one or more frames (e.g., acknowledgement (ACK) frames) in response to message 231.

Information (e.g., included in messages 231 and 232) exchanged between stations 101 and 102 in phase 230 may overlap information exchanged between stations 101 and 102 in phase 210, phase 220, or both phases 210 and 220. For example, information in message 231 may overlap information in message 211, 221, or both messages 211 and 221. Information in message 232 may overlap information in message 212, 222, or both messages 212 and 222. For example, for a USB protocol, messages 231 and 232 may include information for a USB enumeration process. Device descriptors exchanged in phase 230 may carry similar or the same information as that of phase 220. In phase 230, a service descriptor of a device may be exchanged without the overhead limitation that may be present in phase 210 and phase 220.

Service-specific information exchanged between stations 101 and 102 may be performed based on protocols according to Layer 2 of the Open Systems Interconnection (OSI) model before stations 101 and 102 establish a wireless connection with each other at a higher layer of the OSI model. For example, messages in phases 210, 220, and 230 (e.g., messages 211, 212, 221, 222, 231, and 232) and authentication procedure 226 and association procedure 227 may be transmitted at the MAC over data frames.

FIG. 1 and FIG. 2 show only two stations (e.g., stations 101 and 102) in wireless network 100 as an example. The number of stations may vary. For example, wireless network 100 may include three or more stations that may be in proximity of each other and may wirelessly communicate among each other. Thus, in FIG. 2, two or more stations (e.g., station 102 and another) may respond to message 211 sent by station 101 if station 101 is in proximity of two or more stations. For example, in an alternative arrangement, a third station (not shown in FIG. 1 and FIG. 2) may also send a response message (e.g., probe response frame) to station 101 in response to message 211 sent by station 101. Such a message from the third station may be similar to message 212 sent by station 102. Thus, in the alternative arrangement, station 101 may receive response messages from both station 102 and a third station. In this case, station 101 may have an option to select which of station 102 or the third station to connect to based on response messages received by station 101.

The description above with reference to FIG. 1 and FIG. 2 gives an example where station 101 may request a service offered by another station (e.g., station 102). Station 101, however, may operate to provide its service to another station if requested. For example, in another service discovery different from service discovery 205, station 101 may respond to a message (e.g., service discovery probe request) sent by station 102 or by another station different from station 102. In this example, station 101 may exchange messages in multiple phases with the other station in a fashion similar to or identical to that used by station 102 in phases 210, 220, and 230 described above. For example, station 101 may send messages similar to messages 212, 222, and 232 of FIG. 2 in a different service discovery where station 101 may provide a service to another station. Thus, a station described herein, such as station 101 or station 102, may be a service requester (e.g., service user) at one time and a service provider at another time.

The multiple-phase service discovery (e.g., three-phase service discovery, such as service discovery 205) described herein may be efficient in terms of overhead and may be scalable. For example, service information may be divided into different portions for transferring in different phases (e.g., phases 210, 220, and 230) of the service discovery. Thus, the multiple-phase service discovery described herein may be suitable for a variety of types of usages and stations. Moreover, since only limited information (e.g., service type and station identification) may be exchanged between stations (e.g., stations 101 and 102) in an initial phase (e.g., phase 210 in FIG. 2) of the service discovery (e.g., service discovery 205), power consumption may also be reduced. The service discovery described herein (e.g., service discovery 205) may fit discovery models of some wireless communication standards, such as those employed by Wi-Fi Alliance, WiGig Alliance, or others. Thus, as an example, the service discovery described herein may be applicable across all frequency bands in which Wi-Fi Alliance certified devices and WiGig devices may operate.

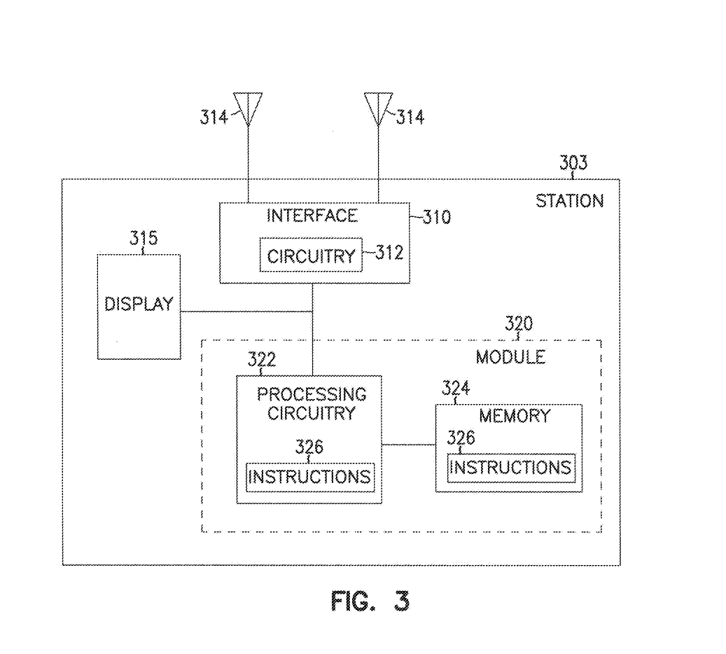

FIG. 3 shows a block diagram of a station 303 including an interface 310, a display 315, and a module 320, according to some embodiments described herein. Station 303 may include any station described above with reference to FIG. 1 and FIG. 2. Thus, station 303 may include a wireless communication station (e.g., station 101 or 102) that may be arranged (e.g., configured) to perform operations similar or identical to those described above with reference to FIG. 1 and FIG. 2. For example, station 303 may include station 101 or 102 that may perform service discovery 205 described above with reference to FIG. 1 and FIG. 2.

In FIG. 3, interface 310 may include circuitry 312 coupled to antennas 314 to wirelessly exchange (e.g., send and receive) messages with other stations (not shown in FIG. 3). For example, circuitry 312 may include a receiver circuit (not shown in FIG. 3) to receive messages and a transmitter circuit (not shown in FIG. 3) to transmit messages. Such receiver and transmitter circuits may be combined in a transceiver in circuitry 312. Interface 310 may be arranged to operate in IEEE 802.11 wireless networks, such that interface 310 may send and receive messages according to IEEE 802.11 standards.

Antennas 314 may include one or more directional or omnidirectional antennas. For example, antennas 314 may include dipole antennas, monopole antennas, patch antennas, loop antennas, microstrip antennas, or other types of antennas suitable for transmission of radio frequency (RF) signals. In some embodiments of station 303, instead of two or more antennas, a single antenna with multiple apertures may be used. In such embodiments, each aperture may be considered a separate antenna.

Display 315 may include a liquid crystal display (LCD), a touch screen, or other types of displays.

Module 320 may include processing circuitry 322 and a memory 324. Processing circuitry 322 may include a single processor or multiple processors. The processor or processors may include one or more general purpose processors, one or more application-specific integrated circuits (ASICs), or other types of processors. Processing circuitry 322 may arrange (e.g., configure) messages for transmission by interface 310 (e.g., by a transceiver in circuitry 312) to other stations. Processing circuitry 322 may be arranged to communicate with the interface 310 to wirelessly exchange messages with other stations.

Memory 324 may include volatile memory, non-volatile memory, or a combination of both. Memory 324 may store instructions 326 (e.g., firmware programs, software programs, or a combination of both) for execution by one or more processors (e.g., included in processing circuitry 322) to configure station 303 for performing operations. Such operations may include service discovery (service discovery 205) described above with reference to FIG. 1 and FIG. 2.

Station 303 in FIG. 3 may be arranged to communicate with a single type of network or with multiple types of networks. For example, station 303 may be arranged to communicate with Wi-Fi networks, Wi-Gig networks, cellular networks, or a combination of these networks.

Although station 303 is illustrated as having several separate functional elements, one or more of the functional elements may be combined and may be implemented by combinations of software-configured elements, such as processing elements including digital signal processors (DSPs), and/or other hardware elements.

The embodiment associated with apparatuses (e.g., stations 101, 102, and 303) and methods (e.g., operations associated with station 101, 102, and 303) may be implemented in hardware, firmware, software, or a combination of hardware, firmware and software. These embodiments may also be implemented as instructions (e.g., instructions 326 in FIG. 3) stored on a computer-readable storage device (e.g., memory 324 and/or a storage device in processing circuitry 322), which may be read and executed by at least one processor (e.g., processing circuitry 322 or a processor included processing circuitry 322) to perform the operations described herein. A computer-readable storage device may include any non-transitory mechanism for storing information in a form readable by a machine (e.g., a computer). For example, a computer-readable storage device may include read-only memory (ROM), random-access memory (RAM), magnetic disk storage media, optical storage media, flash-memory stations, and other storage stations and media. In some embodiments, one or more processors may be arranged with instructions stored on a computer-readable storage device to implement the various operations described herein.

The illustrations of apparatuses (e.g., stations 101, 102, and 303) and methods (e.g., operations associated with stations 101, 102, and 303) are intended to provide a general understanding of the structure of various embodiments and are not intended to provide a complete description of all the elements and features of apparatuses that might make use of the structures described herein.

Stations 101, 102, and 303 may be included in apparatuses (e.g., electronic circuitry) such as high-speed computers, communication and signal processing circuitry, single or multi-processor modules, single or multiple embedded processors, multi-core processors, message information switches, and application-specific modules including multilayer, multi-chip modules. Such apparatuses may further be included as sub-components within a variety of other apparatuses (e.g., electronic systems), such as televisions, cellular telephones, personal computers (e.g., laptop computers, desktop computers, handheld computers, tablet computers, etc.), workstations, radios, video players, audio players (e.g., MP3 (Motion Picture Experts Group, Audio Layer 5) players), vehicles, medical stations (e.g., heart monitor, blood pressure monitor, etc.), set top boxes, and others.

The embodiments described above with reference to FIG. 1, FIG. 2, and FIG. 3 include apparatuses and methods to send a first message from a first wireless communication station during service discovery to discover a service supported by a second wireless communication station. The first wireless communication station may also send a second message to the second wireless communication station if the first wireless communication station receives a response message from the second wireless communication station indicating that the service included in the first message is supported by the second wireless communication station. The second message may include more information about the service than the first message. The first message may be sent before a wireless connection is established between the first and second wireless communication stations. Other embodiments including additional apparatuses and methods are described.

The above description and the drawings illustrate some embodiments to enable those skilled in the art to practice the embodiments of the inventions. Other embodiments may incorporate structural, logical, electrical, process, and other changes. Examples merely typify possible variations. Portions and features of some embodiments may be included in, or substituted for, those of others. Many other embodiments will be apparent to those of skill in the art upon reading and understanding the above description. Therefore, the scope of various embodiments of the invention is determined by the appended claims, along with the full range of equivalents to which such claims are entitled.

The Abstract is provided to comply with 37 C.F.R. Section 1.72(b) requiring an abstract that will allow the reader to ascertain the nature and gist of the technical disclosure. It is submitted with the understanding that it will not be used to limit or interpret the scope or meaning of the claims. The following claims are hereby incorporated into the detailed description, with each claim standing on its own as a separate embodiment.

What is claimed is:

1. A wireless communication station arranged to:
send a first message during service discovery to discover a service supported by an additional wireless communication station; and
send a second message to the additional wireless communication station if the wireless communication station receives a third message from the additional wireless communication station indicating that the service indicated in the first message is supported by the additional wireless communication station, wherein the second message includes more information about the service than the first message, and the first message is sent before a wireless connection is established between the wireless communication station and the additional wireless communication station.

2. The wireless communication station of claim 1, wherein the second message is sent before the wireless connection is established.

3. The wireless communication station of claim 1, wherein the first message includes a type of service to be discovered without additional specific information about the service.

4. The wireless communication station of claim 1, wherein the type of service includes one or more of video, audio, display, data transfer, and printing.

5. The wireless communication station of claim 1, wherein the first message is sent according to layer 2 communication protocols.

6. A wireless communication station arranged to:
send a first message during service discovery to respond to a second message from an additional wireless communication station if the second message includes information requesting a service supported by the wireless communication station; and
send a third message to provide additional information about the service if the wireless communication station receives a fourth message from the additional wireless communication station requesting the additional information, wherein the first message is sent before a wireless connection is established between the wireless communication station and the additional wireless communication station.

7. The wireless communication station of claim 6, wherein the information requesting the service included in the second message does not include device type, device vendor, service capabilities, service version, service function, and user friendly text associated with the service.

8. The wireless communication station of claim 6, wherein the additional information about the service includes at least one of device type, device vendor, service capabilities, service version, service function, and user friendly text.

9. The wireless communication station of claim 6, wherein the third message is sent before the wireless connection is established.

10. A wireless communication station comprising:
an antenna;
an interface coupled to the antenna; and
a module to communicate with the interface and arranged to:
send a first message during service discovery to discover a service supported by an additional wireless communication station; and
send a second message to the additional wireless communication station if the wireless communication station receives a third message from the additional wireless communication station indicating that the service included in the first message is supported by the additional wireless communication station, where the second message includes more information about the service than the first message, and the first message is sent before an association procedure is performed by the wireless communication station and the additional wireless communication station.

11. The wireless communication station of claim 10, wherein the first message includes information about the service to be discovered, and the information includes only a type of service.

12. The wireless communication station of claim 10, wherein the type of service includes one of High-Definition Multimedia Interface (HDMI), wireless fidelity (Wi-Fi) display, and Universal Serial Bus (USB).

13. The wireless communication station of claim 10, wherein the second message is sent before the association procedure is performed.

14. The wireless communication station of claim 10, wherein the second message is sent after the association procedure is performed.

15. The wireless communication station of claim 10, wherein the module is further arranged to terminate the service discovery between the wireless communication station and the additional wireless communication station if one of the wireless communication station and the additional wireless communication station decides not to connect to each other after the first and second messages are sent.

16. The wireless communication station of claim 10, wherein the second message includes at least one generic advertisement service (GAS) frame.

17. The wireless communication station of claim 10, wherein the first message and the second message include data frames sent in a medium access control (MAC) layer.

18. The wireless communication station of claim 10, wherein the module is further arranged to respond to a request to provide a service to another wireless communication station during an additional service discovery.

19. The wireless communication station of claim 10, wherein the interface is arranged to send the first and second message according to IEEE 802.11 standards.

20. A non-transitory computer-readable storage medium that stores instructions for execution by one or more processors to configure a wireless communication device for performing operations, the operations comprising:
sending a first message during service discovery to discover a service supported by an additional wireless communication station; and
sending a second message to the additional wireless communication station if the wireless communication station receives a third message from the additional wireless communication station indicating that the service included in the first message is supported by the additional wireless communication station, where the second message includes more information about the service than the first message, and the first message is sent before a wireless connection is established between the wireless communication station and the additional wireless communication station.

21. The non-transitory computer-readable storage medium of claim 20, wherein the second message is sent after the wireless connection is established.

22. The non-transitory computer-readable storage medium of claim 20, wherein the first message includes information about the service to be discovered, and the information includes only a type of service.
